(19) United States
(12) Patent Application Publication
(10) Pub. No.: US 2025/0003192 A1
(43) Pub. Date: Jan. 2, 2025

(54) METHOD FOR OPERATING A DRIVE TRAIN OF A WORKING MACHINE

(71) Applicant: ZF FRIEDRICHSHAFEN AG, Friedrichshafen (DE)

(72) Inventors: Matthias MADLENER, Hohentengen (DE); Stephan SCHINACHER, Egesheim (DE); Jürgen LEGNER, Friedrichshafen (DE); Rico GLÖCKNER, Pocking (DE); Andreas ROTHMUND, Hohentengen (DE); Juergen RILLING, Meckenbeuren (DE); Matheus POLATTI, Friedrichshafen (DE)

(21) Appl. No.: 18/707,190

(22) PCT Filed: Nov. 3, 2022
(86) PCT No.: PCT/EP2022/080666

§ 371 Date: May 3, 2024

(30) Foreign Application Priority Data
Nov. 5, 2021 (DE) 10 2021 212 458.5

(51) Int. Cl. E02F 9/20; B60L 15/20

(52) U.S. Cl. CPC E02F 9/2079; B60L 15/2054; E02F 9/2004; E02F 9/207; B60L 2200/40; B60L 2240/14; B60L 2240/32; B60L 2240/486; B60L 2250/24; B60L 2250/26

(57) ABSTRACT

A method for operating a drive train of an electrically driven working machine having a control device that controls the drive train, including receiving and evaluating, via the control device, input commands from a vehicle computer via one respective CAN interface, wherein the input commands include at least a current brake status, a current pedal position, a current gearshift lever position and one of a plurality of predefined dynamic classes stored in the control device. The method further includes mapping an individual speed curve over time, and driving the drive train depending on the one dynamic class that is transmitted to the control device and selected via a respective input command of the input commands.

### CROSS REFERENCE TO RELATED APPLICATIONS

This application is a U.S. National Phase application under 35 U.S.C. § 371 of International Application No. PCT/EP2022/080666, filed on Nov. 3, 2022, and claims benefit to German Patent Application No. DE 10 2021 212 458.5, filed on Nov. 5, 2021. The International Application was published in German on May 11, 2023 as WO 2023/078992 A1 under PCT Article 21 (2).

### FIELD

The invention relates to a method for operating a drive train of a working machine and a control device which is designed to carry out the method.

### BACKGROUND

WO 2016/059115 A1 relates to a device and method for driving a drive train of variable-speed working machines with a constantly running drive and with a high-ratio variable-speed transmission as a superposition transmission. The transmission comprises an input branch, an output branch and a control branch with connectable control machines. The drive train is started up by the output branch being locked by a braking device in the output branch, or by a locking device of the working machine, or for the start-up of the drive and, after the drive has been connected, by the working machine itself removing the locking of the output branch for the start-up and operation of the working machine. A speed zero crossing of the control branch is always present during the start-up of the working machine and during the operation of the working machine in the operating range.

### SUMMARY

In an embodiment, the present disclosure provides a method for operating a drive train of an electrically driven working machine having a control device that controls the drive train, comprising receiving and evaluating, via the control device, input commands from a vehicle computer via one respective CAN interface, wherein the input commands comprise at least a current brake status, a current pedal position, a current gearshift lever position and one of a plurality of predefined dynamic classes stored in the control device. The method further comprises mapping an individual speed curve over time, and driving the drive train depending on the one dynamic class that is transmitted to the control device and selected via a respective input command of the input commands.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a simplified schematic view of a vehicle comprising a drive train, which can be controlled according to a method according to an embodiment of the invention;

FIG. 2 shows a diagram for illustrating an acceleration behavior of the working machine according to FIG. 1 in different dynamic classes;

FIG. 3 shows a diagram for illustrating a deceleration behavior of the working machine according to FIG. 1 in different dynamic classes;

FIG. 4 shows a diagram for illustrating a reversing behavior of the working machine according to FIG. 1 in different dynamic classes; and

FIG. 5 shows a diagram for illustrating exemplary tractive force curves of the working machine according to FIG. 1.

### DETAILED DESCRIPTION

In an embodiment, the present invention provides a method for operating a drive train of a working machine by which specific application requirements regarding the dynamics of the working machine can be met in an improved manner.

According to a method according to an embodiment of the invention for operating a drive train of an electrically driven working machine, comprising a control device that controls the drive train, wherein the control device is designed to receive and evaluate input commands from a vehicle computer via one respective CAN interface, wherein the input commands comprise at least a current brake status, a current pedal position, a current gearshift lever position and one of a plurality of predefined dynamic classes stored in the control device, wherein each dynamic class maps an individual speed curve over time, the drive train is driven depending on the dynamic class that is transmitted to the control device and selected via the respective input command. Driving maneuvers for electrical construction machine systems can be designed dynamically via the dynamic classes. Depending on its design and its particular devices which are fixedly connected to the vehicle, a working machine is a machine which is provided for carrying out work but not primarily for conveying people or goods. For example, this includes agricultural machines, construction machines and wheel loaders.

The driver of the working machine has access to the vehicle computer which is connected in terms of control technology, in particular by means of one or more CAN interfaces, to the control device. The driver operates operating elements in order to generate manual input commands, wherein the vehicle computer (also called the VCU “Vehicle Control Unit”) reads the manual input commands and forwards or transmits via the CAN interfaces the corresponding information as electrical input commands to the control device which is to be understood as the transmission controller (also called the eDCU “Electric Drive Control Unit”) of the drive train. On the basis of the input commands, the control device determines the driving strategy of the working machine. Operating elements within the meaning of the present disclosure are a brake pedal or brake lever, a gas pedal and a gearshift lever. It is also possible to provide button elements or a corresponding touch display, one of the dynamic classes being able to be selected thereby.

As a result, the driver can influence the current brake status by manual actuation of the operating elements, for example by a corresponding actuation of a brake lever or brake pedal, the current pedal position, in particular the pedal position of the gas pedal and the brake pedal, the current gearshift lever position, which in particular is used to set whether the working machine is in a neutral position, in a forward drive mode or in a reverse drive mode, and adopt the dynamic classes.

The dynamic classes are stored on the control device, wherein the driver of the working machine can select at least one of the dynamic classes as desired by means of the operating elements. By selecting a desired dynamic class, the driver selects, for a driving maneuver, a specific time-dependent speed curve of a transmission output of the drive train from a plurality of differently defined speed curves which are stored in the dynamic classes. In particular, the driver can select a separate dynamic class for each direction of travel and for different driving maneuvers, in particular an acceleration, a deceleration or a reversing of the working machine. Within the meaning of this disclosure, therefore, a driving maneuver is to be understood to mean, in particular, an acceleration process, a deceleration process and a reversing process.

Thus a driving behavior of the working machine can be variably adapted for different purposes, in particular in electrical drive systems of working machines. Such an adaptation of a speed curve can be required, for example, for a sensitive approaching movement of the working machine when unloading heavy objects. A different speed curve can be required for the respective driving maneuver from that required when travelling overland and/or in the case of an unloaded working machine. If higher or lower speeds are referred to, this always means one respective point in time in the driving maneuver. A first dynamic class can implement a lower transmission output speed at a specific point in time of the driving maneuver, whereas in a second dynamic class a higher transmission output speed is implemented at the same comparable point in time of the driving maneuver. The dynamic classes can be adapted in each case to specific fields of application and purposes in order to design the drive of the drive train to be as efficient as possible and to react to the prevailing conditions according to the situation.

Preferably, each dynamic class maps an individual time-dependent speed curve for implementing an acceleration behavior, a deceleration behavior and/or a reversing behavior. In other words, for each driving maneuver a plurality of dynamic classes are defined and stored on the control device. A dynamic class which can be set for the variable adaptation of the acceleration behavior is called the “Requested Maximum Acceleration Class”. A dynamic class which can be set for the variable adaptation of the deceleration behavior is called the “Requested Maximum Deceleration Class”. A dynamic class which can be set for the variable adaptation of the reversing behavior is called the “Requested Maximum Reversal Class”.

Preferably, a first group of predefined dynamic classes defines the acceleration behavior of the working machine. During acceleration, in the respective dynamic class of the first group the speed increases over time. Preferably, a greater acceleration of the working machine is implemented with an increasing dynamic class. The greater the acceleration predetermined in the respective dynamic class, the earlier a maximum achievable speed of the working machine is reached or the more rapidly the speed increases in a given time. A start-up of the working machine takes place relatively more rapidly or over a shorter time period. Conversely, the lower the acceleration predetermined in the respective dynamic class, the later the maximum achievable speed of the working machine is reached. A start-up of the working machine takes place relatively more slowly or over a longer time period. The dynamic classes for the acceleration behavior of the working machine can also be numbered in reverse.

Alternatively or additionally, a second group of predefined dynamic classes defines the deceleration behavior of the working machine. During deceleration or braking of the working machine, in the respective dynamic class of the second group the speed decreases over time. Preferably, a greater deceleration of the working machine is implemented with an increasing dynamic class in the second group. The greater the deceleration predetermined in the respective dynamic class, the earlier a standstill of the working machine or a minimum transmission output speed of the transmission output is achieved or the more rapidly the speed is reduced in a given time. Conversely, the lower the deceleration predetermined in the respective dynamic class, the later the standstill of the working machine or the minimum transmission output speed is achieved. The dynamic classes for the deceleration behavior of the working machine can also be numbered in reverse.

Alternatively or additionally, a third group of predefined dynamic classes defines the reversing behavior of the working machine. A reversing request can be transmitted to the control device via the operating elements, in particular the gearshift lever. With the presence of such a reversing request, for example, a drive clutch of the drive train is opened in order to decouple a reversing gear from the output of the drive train. Subsequently a change in rotational direction is initiated in the reversing gear. Then the drive clutch is at least indirectly closed in order to connect the reversing gear again operatively to the output and initially to brake the working machine fully and then to accelerate the working machine in the opposing direction of travel. A drive clutch is understood to mean a switching element which has an open state for disconnecting a rotational connection, a closed state for transmitting a torque and a speed, and a plurality of intermediate states for transmitting a respective torque component and a respective speed component between two shafts. The reversing clutch is configured, for example, as a friction clutch.

The term “at least indirectly” is to be understood to mean that two components are (operatively) connected to one another via at least one further component which is arranged between the two components, or are connected in a direct manner, and thus directly, to one another. Thus further components can be arranged, which are operatively connected to the reversing gear or the output and can be coupled to one another by means of the drive clutch, between the reversing gear and the output of the drive train.

The term “operatively connected” is to be understood to mean a non-switchable connection between two components which are provided for a permanent transmission of a drive power, in particular a speed and/or a torque. The connection can take place both directly or via a fixed transmission. The connection can take place, for example, via a fixed shaft, a toothing, in particular a spur gear toothing, and/or a belt means. A drive power, in particular a speed and a torque, can be transmitted via the connection.

When reversing, initially the speed decreases over time until the working machine comes to a standstill or until a minimum transmission output speed is achieved, before an acceleration is initiated in the described manner in the opposing direction of travel and the speed increases over time. The acceleration can take place in a manner similar to the above-described case and dynamically adapted by the respective dynamic classes for the acceleration behavior of the working machine. Preferably, a more rapid reversing of the working machine is implemented in the third group with an increasing dynamic class. The more rapidly the reversing is predetermined in the respective dynamic class, the earlier a standstill of the working machine or a minimum transmission output speed is achieved or the more rapidly the speed is reduced in a given time and the more rapidly a reversal of the rotational direction of the reversing gear and thus a reversal of the direction of travel is achieved. Conversely, the more slowly the reversing is predetermined in the respective dynamic class, the later the standstill of the working machine or the minimum transmission output speed or the reversal of the rotational direction of the reversing gear or the reversal of the direction of travel is achieved. The dynamic classes for the reversing behavior of the working machine can also be numbered in reverse.

Preferably, at least two defined dynamic classes for each drive direction of the working machine are stored on the control device for the respective group of predefined dynamic classes. The greater the number of dynamic classes stored for the respective group, the more sensitively a desired speed curve can be set on the transmission output over time or the more sensitively an acceleration behavior and/or a deceleration behavior and/or a reversing behavior can be selected for the respective driving maneuver. Preferably, more than five dynamic classes, preferably more than 10 dynamic classes, particularly preferably 15 dynamic classes, are defined for each drive direction in the respective group of dynamic classes. A forward direction of travel and a reverse direction of travel are to be understood as the drive direction of the working machine. In other words, in each group of dynamic classes at least two predefined dynamic classes for the forward direction of travel and in each group of dynamic classes at least two predefined dynamic classes for the reverse direction of travel are stored on the control device. Moreover, at least two predefined dynamic classes are stored in the third group for the reversing or for a reversal of the direction of travel. The dynamic classes can be individually selected for each driving maneuver. For example, a reverse travel of the working machine can be carried out with a low acceleration over time, whereas a forward travel can be carried out with a relatively high acceleration over the same time. The lower or slower the selected acceleration, deceleration or braking and reversing, the better the working machine can be controlled and operated. For example, a dynamic class of the respective driving maneuver can be designed as an ECO mode which implements a particularly energy-saving drive of the working machine. A further dynamic class of the respective driving maneuver can be a normal mode or standard mode as a compromise between performance and energy efficiency. A third dynamic class of the respective driving maneuver can in turn be a power mode.

Preferably, the control device is designed to provide the vehicle computer with information about the currently selected dynamic class and/or the current operation of the drive train. In other words, the control device can also transmit feedback to the vehicle computer and thus make this feedback available to the driver of the working machine. The control device has interfaces corresponding thereto. “Current mode” is to be understood, in particular, to mean a current transmission output speed, a current tractive force or a current output torque, a slip or the like. On the basis of this information about the current operation of the working machine the driver can make a decision as to whether they undertake a change, or not, to the respective dynamic class for the respective drive direction or direction of travel and for the respective upcoming maneuver, i.e. select a different dynamic class. The system can also be designed to transmit suggestions relating to a required change of the dynamic class of the respective group, so that the drive can be designed more efficiently.

Further preferably, the current brake status, the current pedal position and/or the current gearshift lever position are used by the control device to scale an acceleration behavior, a deceleration behavior and/or a reversing behavior of the drive machine as a function of the dynamic class. On the basis of the status of the respective operating element, the control device can adapt a speed curve within the respectively selected dynamic class. In any case, the speed at the transmission output at a specific point in time is at most as high as that predetermined by the respective dynamic class. Depending on the status of the respective operating element, the speed at the defined point in time can also be below the maximum. For example, during the reversing of the working machine, within a dynamic class a reversing can take place more rapidly with a gas pedal fully depressed than with the gas pedal depressed up to half of the lever travel. However, the reversing can only take place to a maximum as rapidly as that predetermined by the respective dynamic class.

Preferably, the control device is designed such that the dynamic classes can be retrospectively changed. “Retrospectively” is to be understood to mean that a change to the factory settings can be undertaken, in particular regarding the dynamic classes. For example, a menu of the control device can be accessed via the vehicle computer or via a further external device in order to adapt as desired the dynamic classes in the respective group or for the respective maneuver. The dynamic classes can be adapted according to the requirement profile and field of use of the working machine in order to design the drive of the working machine to be more energy-efficient, for example for a specific field of use.

According to an exemplary embodiment, the input commands also comprise one of a plurality of predefined tractive power classes stored in the control device, wherein each tractive power class maps an individual tractive force curve as a function of a transmission output speed, and wherein the drive train is driven as a function of the tractive power class transmitted to the control device and selected via the input command. The tractive power classes are individual dynamic tractive force modes which can be advantageously used for electrical construction machine systems. Such a tractive power class is called the “Requested Tractive Power Upper Limit Class”.

The tractive power classes are stored on the control device, wherein the driver of the working machine can select one of these tractive power classes as desired by means of the operating elements. By selecting a desired tractive power class, the driver selects a specific tractive force curve as a function of the transmission output speed of a transmission of the drive train from a plurality of defined tractive force curves which are stored in the tractive power classes. In particular, the driver can select a separate tractive power class for each direction of travel or drive direction of the working machine.

Thus the behavior of the tractive force can be variably adapted for different purposes, in particular in electrical drive systems of working machines. This can be required, for example, in the case of a change in the condition of a road or substrate. If the working machine is used on a hard surface, such as for example asphalt, it can be driven with a high tractive force. In contrast thereto, a lower tractive force can be required when using the working machine on a soft substrate, for example sand, so as not to generate in particular any wheelspin in the heap of material, which would result in a significant reduction in productivity. When discussing higher or lower tractive forces, this always refers to a reference transmission output speed. A first tractive power class with a specific transmission output speed can implement a lower tractive force for the working machine, whereas a higher tractive force can be implemented for the working machine in a second tractive power class with the same transmission output speed. The tractive power classes can be adapted in each case to specific fields of application and purposes in order to design the drive of the drive train as efficiently as possible and to be able to react to the prevailing conditions according to the situation.

Preferably, at least two predefined tractive power classes for each drive direction of the working machine are stored on the control device. The greater the number of tractive power classes stored, the more sensitively a desired tractive force curve can be set. Preferably, more than five tractive power classes, preferably more than 10 tractive power classes, particularly preferably 15 tractive power classes are defined for each drive direction. A forward direction of travel and a reverse direction of travel are to be understood as the drive direction of the working machine. In other words, at least two predefined tractive power classes for the forward direction of travel and at least two predefined tractive power classes for the reverse direction of travel are stored on the control device. The tractive power classes can be individually selected for each drive direction. For example, a reverse travel can be carried out with a small maximum tractive force for a specific transmission output speed, whereas a forward travel can be carried out with a relatively high maximum tractive force for the same transmission output speed. The lower the maximum tractive force of the respective tractive power class, the better the working machine can be controlled and operated. The tractive power classes can also be divided into different modes, similar to the dynamic classes.

An embodiment of the invention further relates to a control device which is designed to carry out the method according to embodiments of the invention. The control device is connected in a signal-transmitting manner at least to the drive train of the working machine, in particular to the drive unit and/or the transmission of the drive train. Moreover the control device can also be connected in a signal-transmitting manner to sensors, for example speed sensors or torque sensors or even pressure sensors which are arranged in the drive train, or further control units or control devices, in particular a vehicle computer and/or an engine control unit.

The above definitions and embodiments for the technical effects, advantages and advantageous embodiments of the method according to embodiments of the invention expediently also apply to the control device according to embodiments of the invention and vice versa. It goes without saying that the features of the solutions described herein or illustrated in the figures can optionally be combined together in order to be able to implement cumulatively the advantages and effects which can be achieved in the present case.

An exemplary embodiment of the invention is described in more detail hereinafter by way of the drawings, wherein elements which are the same or similar are provided with the same reference signs.

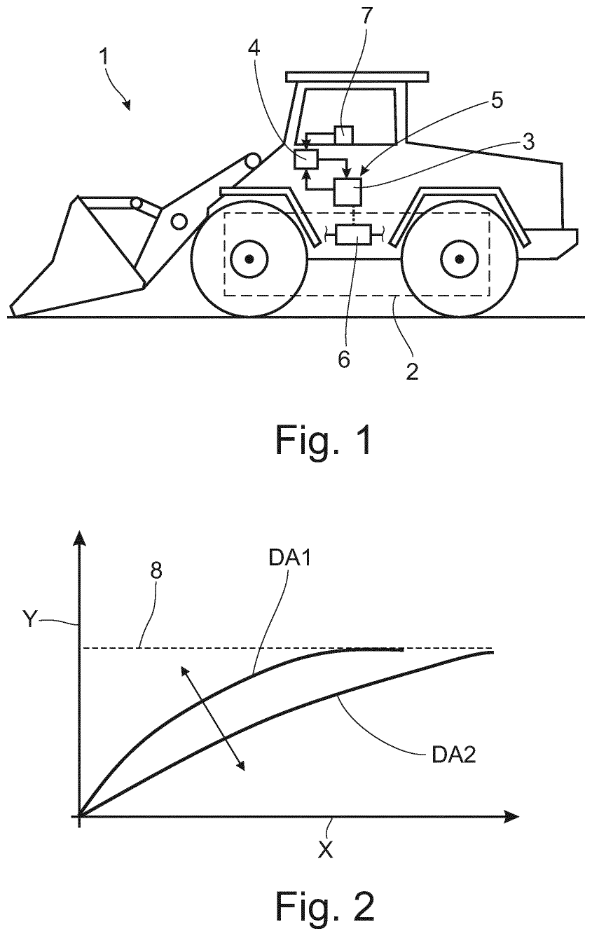

FIG. 1 shows a working machine 1 which is configured as a construction machine. The working machine 1 can move in a forward direction of travel and in an opposing reverse direction of travel. These directions are also denoted as the drive directions. The working machine 1 has a drive train 2 which is indicated here by a rectangle in dashed lines. The drive train 2 has a drive unit which is configured, for example, as an electric machine, and a transmission 6 which is connected in terms of control technology to a control device 3 according to an embodiment of the invention which carries out a method according to an embodiment of the invention which is described hereinafter. The control device 3 can also be connected in a signal-transmitting manner to the drive unit. A drive power can be generated by the drive unit and transmitted via the transmission 6 in the form of a torque and a transmission output speed to the wheels of the working machine 1.

The control device 3 is also connected to a vehicle computer 4 which receives and evaluates input commands from a plurality of operating elements 7 and then forwards these input commands via a CAN interface 5 to the control device 3. The operating elements 7 are a brake pedal, a gas pedal, a gearshift lever, a plurality of button elements for selecting a dynamic class from one respective group of individual dynamic classes and a plurality of button elements for selecting a tractive power class from a group of individual tractive power classes. A plurality of tractive power classes and dynamic classes are stored on the control device 3 for each drive direction or direction of travel of the working machine.

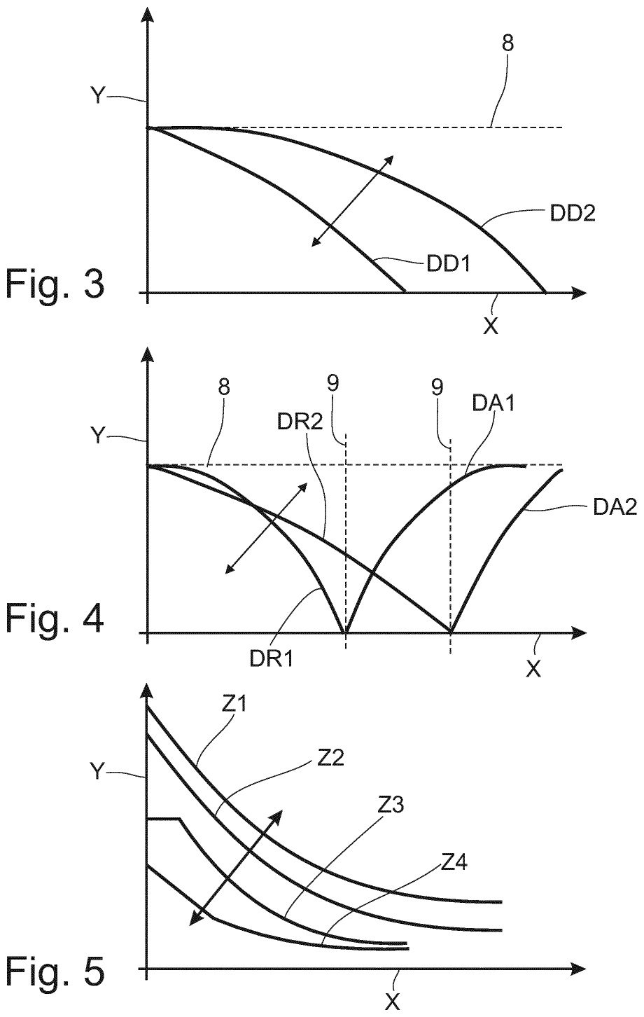

Using the operating elements 7 and depending on the lever travel, the input commands are a current pedal position of the gas pedal for representing a current drive status and a pedal position of the brake pedal for representing a current brake status, a current gearshift lever position, the selection of a dynamic class for an acceleration behavior DA1, DA2 (according to FIG. 2), a deceleration behavior DD1, DD2 (according to FIG. 3) and a reversing behavior DR1, DR2 (according to FIG. 4) in each case from a plurality of predefined dynamic classes stored in the control device 3, and the selection of a tractive power class Z1-Z4 from a plurality of predefined tractive power classes stored in the control device 3.

The dynamic classes are thus divided into a plurality of groups. A first group of predefined dynamic classes DA1, DA2 defines the acceleration behavior of the working machine 1. A second group of predefined dynamic classes DD1, DD2 defines the deceleration behavior of the working machine 1. A third group of predefined dynamic classes DR1, DR2 defines the reversing behavior of the working machine 1. Thus each dynamic class maps an individual time-dependent speed curve for implementing an acceleration behavior, a deceleration behavior or a reversing behavior. For the respective group of predefined dynamic classes at least two defined dynamic classes for each drive direction of the working machine 1 and each of the aforementioned driving maneuvers are stored on the control device 3.

Via the gearshift lever position it is predetermined whether the working machine 1 is to be driven in forward travel mode or in reverse travel mode, or whether the drive train 2 is in a neutral position, i.e. neither a forward travel mode nor a reverse travel mode is implemented. Moreover, a reversing request can be transmitted to the control unit via the gearshift lever position.

A diagram is shown in FIG. 2 to FIG. 5 in each case in order to illustrate the method according to an embodiment of the invention for operating the drive train 2 of the working machine 1 shown in FIG. 1. In FIG. 2 to FIG. 4 a transmission output speed of the transmission 6 is plotted on a Y-axis, for example, as the unit “revolutions per minute” or “rpm”, and wherein the time is plotted on an X-axis of the diagram, for example, as the unit “seconds” or “minutes”.

According to FIG. 2 a first speed curve for a first dynamic class DA1 and a second speed curve for a second dynamic class DA2, which in each case describe an acceleration behavior of the working machine 1 for a forward travel, are mapped in the diagram. The dynamic classes for the acceleration behavior can be configured identically in reverse travel of the working machine 1. More than two dynamic classes can also be provided for the acceleration behavior for the respective direction of travel. This is to be illustrated by the arrow in FIG. 2.

Each of the dynamic classes DA1, DA2 shown here maps an individual speed curve as a function of the time, wherein a maximum available speed is plotted for each dynamic class DA1, DA2 at each point in time of the driving maneuver. These points are joined together and form the speed curves shown here. Depending on which of these dynamic classes is selected by the driver via the corresponding operating elements 7, the drive train 2 is driven as a function of the dynamic class transmitted to the control device 3 and selected via the respective input command. In the respective dynamic class DA1, DA2 the speed increases over time. The first dynamic class DA1 for the acceleration behavior of the working machine 1 can implement a power mode in which the drive train 2 of the working machine 1 implements a more steeply rising speed curve. The second dynamic class DA2 for the acceleration behavior of the working machine 1 can accordingly be an ECO mode in order to implement an energy-saving drive of the working machine 1 in comparison with the first dynamic class DA1. The dynamic classes DA1, DA2 for the acceleration behavior are designed such that in the first dynamic class DA1 a maximum torque of the working machine 1, here shown by the horizontal dashed line 8, is achieved earlier than in the second dynamic class DA2, with the proviso that all remaining operating elements 7, with the exception of the operating elements 7 for selecting the dynamic classes DA1, DA2 for the acceleration behavior, transmit the same input commands to the control device 3. Conversely, the transmission output, in particular a transmission output shaft, in the second dynamic class DA2 achieves the maximum possible speed of the working machine 1 later than in the first dynamic class DA1. Moreover, with increasing dynamic classes a higher available maximum speed for the drive of the drive train 2 of the working machine 1 is provided earlier until the maximum speed is achieved. Thus a greater acceleration of the working machine 1 is implemented with an increasing dynamic class.

According to FIG. 3 a first speed curve for a first dynamic class DD1 and a second speed curve for a second dynamic class DD2, which in each case describe a deceleration behavior of the working machine 1 or a braking behavior for a forward travel, are mapped in the diagram. The dynamic classes for the deceleration behavior can be configured identically in reverse travel of the working machine 1. More than two dynamic classes can also be provided for the deceleration behavior for the respective direction of travel. This is to be illustrated by the arrow in FIG. 3.

Each of the dynamic classes DD1, DD2 shown here maps an individual speed curve as a function of the time, wherein a maximum available speed is plotted for each dynamic class DD1, DD2 at each point in time of the driving maneuver. These points are joined together and form the speed curves shown here. Depending on which of these dynamic classes is selected by the driver via the corresponding operating elements 7, the drive train 2 is driven as a function of the dynamic class transmitted to the control device 3 and selected via the respective input command. In the respective dynamic class DD1, DD2, starting from a maximum speed which can be achieved by the working machine 1, shown here by a dashed line 8, the speed decreases over time. The first dynamic class DD1 for the deceleration behavior of the working machine 1 can implement a power mode in which the drive train 2 of the working machine 1 implements a more steeply falling speed curve. The second dynamic class DD2 for the deceleration behavior of the working machine 1 can accordingly be an ECO mode in order to implement an energy-saving drive of the working machine 1 in comparison with the first dynamic class DD1. The dynamic classes DD1, DD2 for the deceleration behavior are designed such that in the first dynamic class DD1 a standstill of the working machine 1 or a minimum speed at the transmission output is achieved earlier than in the second dynamic class DD2, with the proviso that all remaining operating elements 7, with the exception of the operating element 7 for selecting the dynamic classes DD1, DD2 for the deceleration behavior, transmit the same input commands to the control device 3. Conversely, the working machine 1 in the second dynamic class DD2 reaches a standstill later or the transmission output achieves the minimum speed of the working machine 1 later than in the first dynamic class DD1. The minimum speed on the transmission output or the standstill of the working machine 1 is achieved earlier with an increasing dynamic class. Thus a greater deceleration of the working machine 1 is implemented with an increasing dynamic class.

According to FIG. 4 a first speed curve for a first dynamic class DR1 and a second speed curve for a second dynamic class DR2, which in each case describe a reversing behavior of the working machine 1 or a reversal of the direction of travel, are mapped in the diagram. The dynamic classes for the reversing behavior can be configured identically in reverse travel of the working machine 1. More than two dynamic classes can also be provided for the reversing behavior for the respective direction of travel. This is to be illustrated by the arrow in FIG. 4.

Each of the dynamic classes DR1, DR2 shown here maps an individual speed curve as a function of the time, wherein a maximum available speed is plotted for each dynamic class DR1, DR2 at each point in time of the driving maneuver. These points are joined together and form the speed curves shown here. Depending on which of these dynamic classes is selected by the driver via the corresponding operating elements 7, the drive train 2 is driven as a function of the dynamic class transmitted to the control device 3 and selected via the respective input command. In the respective dynamic class DR1, DR2, starting from a maximum speed which can be achieved by the working machine 1, shown here by a dashed line 8, the speed decreases over time. The first dynamic class DR1 for the reversing behavior of the working machine 1 can implement a power mode in which the drive train 2 of the working machine 1 implements a more steeply falling speed curve. The second dynamic class DR2 for the reversing behavior of the working machine 1 can accordingly be an ECO mode in order to implement an energy-saving drive of the working machine 1 in comparison with the first dynamic class DD1. The dynamic classes DR1, DR2 for the reversing behavior are designed such that in the first dynamic class DR1 a reversing or a reversal of the direction of travel of the working machine 1 is achieved earlier than in the second dynamic class DR2, with the proviso that all remaining operating elements 7, with the exception of the operating elements 7 for selecting the dynamic classes DR1, DR2 for the reversing behavior, transmit the same input commands to the control device 3. Conversely, the reversal of the direction of travel in the second dynamic class DD2 takes place later than in the first dynamic class DR1. The minimum speed on the transmission output or the standstill of the working machine 1 is achieved earlier with an increasing dynamic class. Thus a more rapid reversing of the working machine 1 is implemented with an increasing dynamic class. The point in time of the reversal of the direction of travel is shown here for each dynamic class DD1, DD2 by the vertical line 9. After this point in time, a start-up of the working machine 1 can take place for the first dynamic class DR1 for the reversing behavior with the first dynamic class DA1 for the acceleration behavior and can take place for the second dynamic class DR2 for the reversing behavior with the second dynamic class DA2 for the acceleration behavior. It is also provided that the start-up can take place on the basis of a selection previously made or a preset dynamic class.

In the diagram according to FIG. 5 a transmission output speed of the transmission 6 is plotted on the X-axis, for example, as the unit “revolutions per minute” or “rpm”, wherein a tractive force of the drive train 2 is plotted on a Y-axis, for example as the unit “Newtons/meter” or “Nm”. Four exemplary tractive power classes Z1-Z4 are shown in the diagram, in the present case for a forward travel of the working machine. The tractive power classes for the reverse travel can be configured identically. A greater or smaller number than four tractive power classes can also be provided for the respective direction of travel, but in any case at least two tractive power classes. This is to be illustrated by the arrow in FIG. 5.

Each of the tractive power classes shown in FIG. 5 forms an individual tractive force curve as a function of the transmission output speed, wherein a maximum tractive force is plotted for each tractive power class for each transmission output speed. These points are joined together and form the tractive force curves shown here. Depending on which of these tractive power classes is selected by the driver via the corresponding operating elements 7, the drive train 2 is driven as a function of the tractive power class transmitted to the control device 3 and selected via the respective input command. In the respective tractive power class Z1-Z4 the tractive force decreases exponentially with a rising transmission output speed. The tractive power class Z3 represents a particularity since a capping of the maximum tractive force is provided here at low speeds. This serves for the safe start-up of the working machine 1. Thus a constant tractive force is provided at low speeds. This third tractive power class Z3 can thus be selected as a start-up mode by the driver via the operating elements 7, in particular via the button elements for selecting the respective tractive power class Z1-Z4. The first tractive power class Z1 can implement a power mode in which the drive train 2 of the working machine 1 implements the greatest possible tractive force. The second tractive power class Z2 can be a normal mode in which a compromise is made between efficiency and performance. The fourth tractive power class Z4 can be selected as an ECO mode in order to implement an energy-saving drive of the working machine 1. Thus with an increasing tractive power class a higher maximum available tractive force is available as a function of the respective transmission output speed for the drive of the drive train 2 of the working machine 1.

The system is designed such that a gradient of a target torque is adapted when changing between two tractive power classes when driving the working machine 1. Thus an abrupt change between two tractive power classes is avoided. In addition, the system also ensures that a gradient limitation is implemented for each tractive power class in order to avoid an abrupt drive of the working machine 1, for example with sudden braking or acceleration. Thus a gradient of a target torque is adapted when changing the current brake status, the current pedal position and/or the current gearshift lever position. Moreover, a gradient of a target speed can be adapted when changing between two dynamic classes when driving the working machine 1, in order to avoid an abrupt change between the two dynamic classes.

The status of the operating elements 7, in particular on the basis of the current brake status, the current pedal position of the gas pedal and brake pedal, and the current gearshift lever position is used by the control device 3 to scale the acceleration behavior, the deceleration behavior and the reversing behavior of the working machine 1 as a function of the dynamic class in the respective group. The graphs shown in FIG. 2 to FIG. 4 show the maximum speed which can be implemented at any point in time. It is thus provided, for example with a full gas position, a half gas position or a quarter gas position of the gas pedal, that a corresponding adaptation of the target torque takes place by suitable scaling.

The status of the operating elements 7, in particular on the basis of the current brake status, the current pedal position of the gas pedal and brake pedal and the current gearshift lever position, is also used by the control device 3 to scale a tractive force as a function of the tractive power class. The graphs shown in FIG. 5 show the maximum tractive force as a function of the transmission output speed. It is thus provided, for example in a full gas position, a half gas position or a quarter gas position of the gas pedal, that a corresponding adaptation of the target tractive force or a reference output torque takes place by suitable scaling.

The control device 3 is also designed to provide the vehicle computer 4 with information about the currently selected dynamic class for the corresponding group, the currently selected tractive power class and/or the current operation of the drive train 2. Thus the driver can obtain information about a current transmission output speed, a current tractive force or output torque, a speed or an occurring slip. On the basis of this information, the driver can change the input commands of the operating elements 7 or select a different dynamic and/or tractive power class which is more suitable for the current drive mode. The control device 3 is also designed such that the tractive power classes and the dynamic classes can be retrospectively changed.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

1 Working machine
2 Drive train
3 Control device
4 Vehicle computer
5 CAN interface
6 Transmission
7 Operating element
8 Horizontal, dashed line
9 Vertical, dashed line
X X-axis
Y Y-axis
DA1 First dynamic class for an acceleration behavior
DA2 Second dynamic class for an acceleration behavior
DD1 First dynamic class for a deceleration behavior
DD2 Second dynamic class for a deceleration behavior
DR1 First dynamic class for a reversing behavior
DR2 Second dynamic class for a reversing behavior
Z1 First tractive power class
Z2 Second tractive power class
Z3 Third tractive power class
Z4 Fourth tractive power class

1. A method for operating a drive train of an electrically driven working machine having a control device that controls the drive train, comprising:
receiving and evaluating, via the control device, input commands from a vehicle computer via one respective CAN interface, wherein the input commands comprise at least a current brake status, a current pedal position, a current gearshift lever position and one of a plurality of predefined dynamic classes stored in the control device;
mapping an individual speed curve over time; and
driving the drive train depending on the one dynamic class that is transmitted to the control device and selected via a respective input command of the input commands.

2. The method as claimed in claim 1, wherein each of the dynamic classes maps an individual time-dependent speed curve for implementing an acceleration behavior, a deceleration behavior and/or a reversing behavior.

3. The method as claimed in claim 2, wherein a first group of predefined dynamic classes defines the acceleration behavior of the working machine.

4. The method as claimed in claim 3, wherein a greater acceleration of the working machine is implemented with an increasing dynamic class.

5. The method as claimed in claim 2, wherein a second group of predefined dynamic classes defines the deceleration behavior of the working machine.

6. The method as claimed in claim 5, wherein a greater deceleration of the working machine is implemented with an increasing dynamic class.

7. The method as claimed in claim 2, wherein a third group of predefined dynamic classes defines the reversing behavior of the working machine.

8. The method as claimed in claim 7, wherein an increasingly rapid reversing of the working machine is implemented with an increasing dynamic class.

9. The method as claimed in claim 3, wherein at least two defined dynamic classes for each drive direction of the working machine are stored on the control device for the first group of predefined dynamic classes.

10. The method as claimed in claim 1, wherein the control device is configured to provide the vehicle computer with information about the selected dynamic class and/or a current operation of the drive train.

11. The method as claimed in claim 1, further comprising using, via the control device, the current brake status, the current pedal position and/or the current gearshift lever position to scale an acceleration behavior, a deceleration behavior and/or a reversing behavior of the working machine as a function of the one dynamic class that is transmitted to the control device.

12. The method as claimed in claim 1, wherein the control device is configured to retrospectively change the dynamic classes.

13. The method as claimed in claim 1, wherein the input commands also comprise one of a plurality of predefined tractive power classes stored in the control device,
wherein each tractive power class maps an individual tractive force curve as a function of a transmission output speed, and
wherein the drive train is driven as a function of the tractive power class transmitted to the control device and selected via a respective input command of the input commands.

14. The method as claimed in claim 13, wherein at least two predefined tractive power classes for each drive direction of the working machine are stored on the control device.

15. A control device configured to carry out the method as claimed in claim 1.

16. The method as claimed in claim 5, wherein at least two defined dynamic classes for each drive direction of the working machine are stored on the control device for the second group of predefined dynamic classes.

17. The method as claimed in claim 7, wherein at least two defined dynamic classes for each drive direction of the working machine are stored on the control device for the third group of predefined dynamic classes.
